(19) United States
(12) Patent Application Publication
(10) Pub. No.: US 2026/0260254 A1
(43) Pub. Date: Sep. 3, 2026

(54) PRODUCT MANAGEMENT SYSTEM, PRODUCT MANAGEMENT METHOD, AND RECORDING MEDIUM

(71) Applicant: NEC Corporation, Tokyo (JP)

(72) Inventors: Hideo URAI, Tokyo (JP); Kanako HATAYAMA, Tokyo (JP)

(73) Assignee: NEC Corporation, Tokyo (JP)

(21) Appl. No.: 19/411,510

(22) Filed: Dec. 8, 2025

(30) Foreign Application Priority Data
Mar. 3, 2025 (KR) 2025-032587

(51) Int. Cl. G06Q 30/0201; G06Q 20/20

(52) U.S. Cl. CPC G06Q 30/02011; G06Q 20/20

(57) ABSTRACT

A product management system includes: at least one memory storing instructions; and at least one processor configured to execute the instructions to: register product information of a product for which an operation of registering in a store has been performed for each customer; display a registered product list of the registered products; receive, on a display screen of the registered product list, selection for each product as to whether to proceed with purchase at the store or to set the product as a favorite product in association with member information of the customer; output, according to the received selection, payment information for proceeding with purchase of the product for a product selected to proceed with purchase at the store; and output, according to the received selection, setting information for setting the product as a customer's favorite product for a product selected to set as the favorite product.

### CROSS-REFERENCE TO RELATED APPLICATION

This application is based upon and claims the benefit of priority from Japanese patent application No. 2025-032587, filed on March 3, 2025, the disclosure of which is incorporated herein in its entirety by reference.

### TECHNICAL FIELD

The present disclosure relates to a product management system and the like.

### BACKGROUND ART

Customer data management is regarded as important in the retail industry. Customer's purchase history and preference information are used for various purposes such as marketing, product development, and improvement of customer service. In particular, it is required to integrally manage online and offline purchasing behavior and provide a seamless customer experience.

JP 2003-281399 A discloses a customer data management system that registers, in a customer analysis database, product data obtained by a customer reading a barcode at a store. In a case where a customer purchases a product at a store, purchase history data is accumulated. In JP 2003-281399 A, even in a case where a customer does not purchase a product, product information is transmitted to a customer-dedicated site and becomes information for customer purchase.

### SUMMARY

A product management system according to an aspect of the present disclosure includes: at least one memory storing instructions; and at least one processor configured to execute the instructions to: register product information of a product for which an operation of registering in a store has been performed for each customer; display a registered product list of the registered products; receive, on a display screen of the registered product list, selection for each product as to whether to proceed with purchase at the store or to set the product as a favorite product in association with member information of the customer; output, according to the received selection, payment information for proceeding with purchase of the product for a product selected to proceed with purchase at the store; and output, according to the received selection, setting information for setting the product as a customer's favorite product for a product selected to set as the favorite product.

A product management method according to an aspect of the present disclosure includes: registering product information of a product for which an operation of registering in a store has been performed for each customer; displaying a registered product list of the registered products; receiving, on a display screen of the registered product list, selection for each product as to whether to proceed with purchase at a store or to set a product as a favorite product in association with member information of a customer; outputting, according to the received selection, payment information for proceeding with purchase of a product for a product selected to proceed with purchase at the store; and outputting, according to the received selection, setting information for setting a product as a customer's favorite product for a product selected to set as the favorite product.

A non-transitory computer-readable recording medium according to an aspect of the present disclosure stores a program that causes a computer to execute processing of: registering product information of a product for which an operation of registering in a store has been performed for each customer; displaying a registered product list of the registered products; receiving, on a display screen of the registered product list, selection for each product as to whether to proceed with purchase at a store or to set a product as a favorite product in association with member information of a customer; outputting, according to the received selection, payment information for proceeding with purchase of a product for a product selected to proceed with purchase at the store; and outputting, according to the received selection, setting information for setting a product as a customer's favorite product for a product selected to set as the favorite product.

### BRIEF DESCRIPTION OF THE DRAWINGS

Exemplary features and advantages of the present disclosure will become apparent from the following detailed description when taken with the accompanying drawings in which:

FIG. 1 is an explanatory diagram illustrating an example of connection between a product management system and another device;

FIG. 2 is a block diagram illustrating a configuration example of the product management system;

FIG. 3 is a view illustrating an example of a selection screen;

FIG. 4 is a view illustrating an example of a confirmation screen of a selection content;

FIG. 5 is a flowchart illustrating an operation example of the product management system;

FIG. 6 is a view illustrating an example of the selection screen;

FIG. 7 is a view illustrating an example of the selection screen;

FIG. 8 is a view illustrating an example of the selection screen; and

FIG. 9 is a block diagram illustrating an example of a hardware configuration of a computer.

### EXAMPLE EMBODIMENT

### First example embodiment

Customers' purchasing behavior is diverse, and the customer may decide to purchase immediately after seeing the product at a store, or may want to consider purchasing later. In the case of an immediate purchase, the customer can take the store product with him/her. In the case of purchasing later, a case of visiting the store again and a case of purchasing online are assumed. A product management system 10 of the present disclosure provides a system that can easily distinguish and manage a product to be immediately purchased and a product to be considered later with respect to a product of interest to a customer in a store. As a result, the customer effectively records the product viewed in the store, and it becomes easy to connect the product to later purchase consideration and actual purchase behavior. In addition, the store side can accurately grasp the product information of interest to the customer and perform appropriate follow-up.

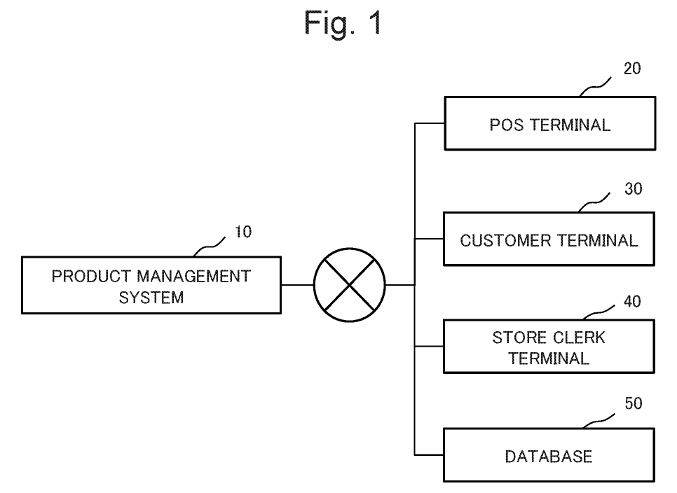

With reference to FIG. 1, a connection example between the product management system 10 and another device according to the present disclosure will be described. The product management system 10 is communicably connected to a point of sales (POS) terminal 20, a customer terminal 30, a store clerk terminal 40, and a database 50 via a communication network.

The POS terminal 20 is a terminal used when a product is sold in a store, and has functions such as product registration, price calculation, and payment processing. The POS terminal 20 may include both displays for customers and for store clerks.

The customer terminal 30 is a terminal operated by a customer. A mobile terminal such as a smartphone is mainly assumed as the customer terminal 30, but the present disclosure is not limited to this. The customer can browse the product information, add the product to the favorite product list, and the like using his/her terminal as the customer terminal 30.

The store clerk terminal 40 is a terminal operated by a store clerk. The store clerk terminal 40 is used as a customer service terminal different from the POS terminal. A tablet-type mobile terminal and the like is mainly assumed as the store clerk terminal 40, but the present disclosure is not limited to this. The store clerk can check the product information in detail, check the stock status, and refer to the customer information using the store clerk terminal 40. In addition, an operation of temporarily registering a product or setting a product as a favorite product may be performed according to a request of a customer. As a result, the store clerk can support the customer's decision to purchase while efficiently serving customers.

The database 50 stores customer data. Specifically, member information of a customer that uniquely identifies the customer is stored. In one example, the database 50 stores a purchase history of the customer, a favorite product list, and the like in association with the member information.

Note that each of the above devices is not necessarily realized as separate hardware. For example, the product management system 10 and the POS terminal 20 may be realized by common hardware. In addition, the functions of the store clerk terminal 40 can be integrated into the POS terminal 20. An appropriate configuration can be selected according to the scale of the system and the operation policy of the store.

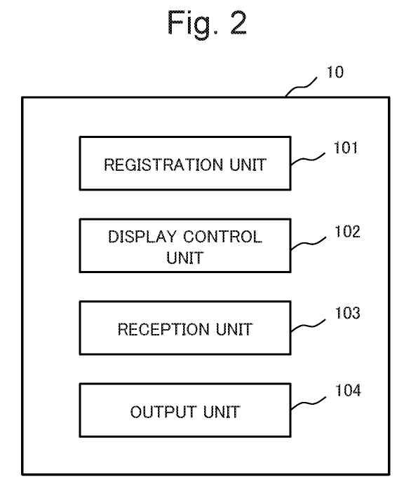

With reference to FIG. 2, a configuration example of the product management system 10 according to the present disclosure will be described. The product management system 10 includes a registration unit 101, a display control unit 102, a reception unit 103, and an output unit 104.

The registration unit 101 registers the product information of the product for which the operation of registering in the store has been performed for each customer. The operation of registering the product is performed, for example, for purchasing the product. However, the registration of the product information is not necessarily performed on the premise of purchase. For example, it is also used for the purpose of recording a product suggested by a store clerk to a customer during service, or a product in which a customer shows an interest.

The operation of registering the product is performed using, for example, the POS terminal 20 or the store clerk terminal 40. In the first example embodiment, it is assumed that a store clerk mainly performs a registration operation. Specific examples of the operation include a method of reading a barcode or a radio tag of a product, and a method of selecting a product on a screen of a terminal. For example, a product code is read using a handheld scanner, or a corresponding product is selected on a touch panel screen. Further, a method of inputting a product code using an input device such as a keyboard can also be employed.

For example, the registration unit 101 acquires the product information of the product subjected to the registration operation from the device subjected to the operation, and temporarily stores the product information. The temporary storage indicates that the information is held until subsequent processing such as purchase or favorite setting is determined, and is then appropriately processed or discarded. This temporary storage allows the system to respond flexibly while the customer is considering product selections. The registered product information includes a product code for specifying a product. The registered product information may further include a product name, a price, a size, a color, and the like.

In one example, the registration unit 101 temporarily registers the member information of the customer and the product information of the product for which the operation of registering in the store has been performed in association with each other. The member information of the customer can be acquired by, for example, reading a barcode of a member card presented by the customer or inputting a member number by the customer or the store clerk. In addition, it is also possible to identify a customer by a method such as biometric authentication and acquire member information.

The display control unit 102 displays a registered product list indicating the products registered by the registration unit 101. This display is performed on, for example, the POS terminal 20 or the store clerk terminal 40. Usually, the list is displayed on the terminal on which the registration operation has been performed in many cases, but can also be displayed on another terminal depending on the system setting. The display screen of the registered product list can display a list of a plurality of registered products. In the present disclosure, the screen of the registered product list displayed by the display control unit 102 allows the user to select whether to proceed with purchase at the store or to suspend the purchase and set the product as a favorite in association with the customer's member information for each registered product. In the following description, a screen of a registered product list displayed by the display control unit 102 is also referred to as a selection screen because it has a function of selecting.

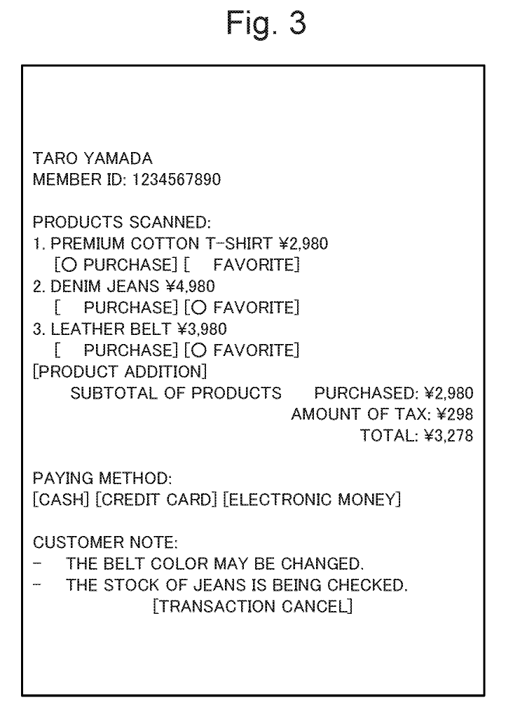

In a case where the selection screen is displayed for the store clerk, the display control unit 102 causes the store clerk side display of the POS terminal 20 or the store clerk terminal 40 to display the selection screen. An example of a selection screen displayed on the store clerk side display will be described with reference to FIG. 3. The screen of FIG. 3 displays customer information, a list of scanned products, and options for each product. The “purchase” option is selected in a case where the customer proceeds with an immediate payment at a store. The option of “favorite” is selected in a case where the purchase is suspended and the product is set as a favorite product in association with the member information of the customer.

The display control unit 102 can also display the selection screen for the customer. For example, it is displayed on the customer side display of the POS terminal 20. The selection screen displayed on the customer side display may have the same contents as the selection screen displayed on the store clerk side display, or may have contents simplified or adjusted for the customer. The display control unit 102 may display the selection screen on both the customer side display and the store clerk side display. In addition, it is also possible to display a selection screen on the store clerk terminal 40 and use the screen in a manner that the store clerk shows the screen to the customer.

On the display screen of the registered product list displayed by the display control unit 102, the reception unit 103 receives, for each product, selection of whether to proceed with the payment at the store or to set the product as a favorite product in association with the member information of the customer. The reception of the selection by the reception unit 103 refers to a series of processes of detecting the user's input, converting it into a form that can be appropriately processed inside the system, and temporarily holding it. In this way, the reception unit 103 enables the purchase and the selection operation of the favorite setting on one screen for the plurality of products included in the registered product list.

In a case where the store clerk performs the selection operation, for example, the store clerk performs the selection by touching a corresponding option on the screen of the touch-panel-type store clerk side display included in the POS terminal 20. In addition, the selection can also be performed using an input device such as a keyboard or a mouse. Similarly, a selection operation can be performed on the store clerk terminal 40. In addition, the reception unit 103 can also accept a selection operation by the customer. For example, in a case where the selection screen is displayed on a touch panel type customer side display, the customer can directly perform an operation. Alternatively, it is also possible to hand over store clerk terminal 40 to the customer for operation.

The reception unit 103 can individually receive the selection for each of the plurality of products displayed on the selection screen. For example, the store clerk selects either “purchase” or “favorite” for each product on the selection screen. The store clerk makes a selection by reflecting the intention of the customer for each product while conducting a dialogue with the customer.

The display control unit 102 displays the received selection content. For example, the selection content is displayed on the selection screen. In a case where the selection operation is performed on the store clerk side display of the POS terminal 20, the display control unit 102 may cause the customer side display to display a confirmation screen indicating the received selection content. For example, as illustrated in FIG. 3, a mark such as a circle is displayed on the selected option on the selection screen to display the selection content.

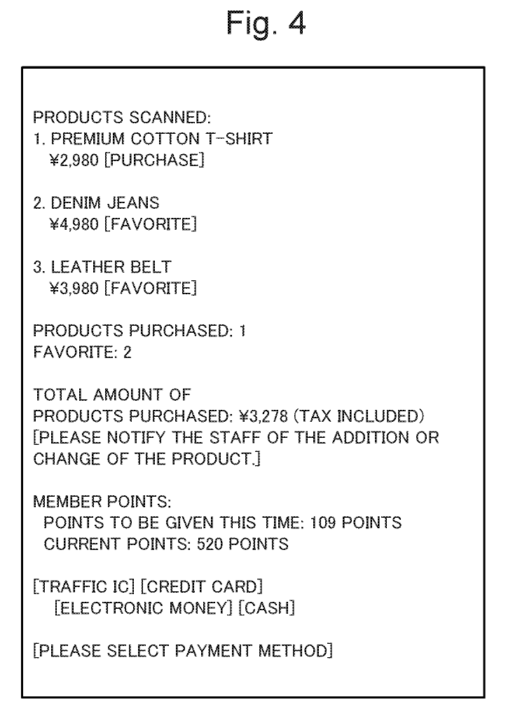

An example of a confirmation screen displayed to the customer will be described with reference to FIG. 4. The confirmation screen of FIG. 4 displays a list of scanned products, a price of each product, and an operation (purchase, favorite, and the like) selected for each product. In addition, summary information such as the total amount of purchased products and the number of products for which “favorite” is selected is also displayed. The customer can check the screen of FIG. 4 and request a change from the store clerk as necessary. The confirmation screen may include additional information and functions. For example, on the screen of FIG. 4, information on member points and options of a payment method are displayed. As a result, the customer can smoothly proceed with a series of processes from the purchase decision to the payment.

The display method of the selected content is not limited to the above example, and the color of the display region of each product may be changed according to the selection content. In addition, the products may be rearranged for each selection content. For example, the products arranged vertically in the scan order, the product genre order, and the like are rearranged with the “purchased” product on the top and the “favorite” product on the bottom. The products may be displayed separately in the “purchase” list and the “favorite” list on the display screen of the selection content.

The output unit 104 outputs information according to the selection received by the reception unit 103. The output unit 104 outputs, before the customer leaves the store, payment information for proceeding with the payment of the product for which the purchase is selected to proceed. In addition, setting information for setting the product selected to be suspended as the customer's favorite product is output. For example, when the customer or the store clerk selects the paying method on the selection screen or the confirmation screen as illustrated in FIG. 3 or FIG. 4, the reception unit 103 determines the selection content for each product. Then, the output unit 104 outputs information such as payment information and setting information according to the determined content.

For the product for which purchase is selected, the output unit 104 outputs, to the POS terminal 20, payment information necessary for payment including, for example, product information, quantity, price, and the like. As a result, the POS terminal 20 can proceed with the payment processing. The POS terminal 20 includes a payment means that performs payment processing based on the payment information output from the output unit 104. The payment means includes, for example, functions such as calculation of a total amount, calculation of a tax amount, selection of a paying method, and issuance of a receipt. Note that, separately from the POS terminal 20, the product management system 10 may include a payment means. In this case, for example, when a payment request is received from the store clerk terminal 40, the payment means executes the payment processing. The payment information is output at the latest before the customer leaves the store, so that the payment processing can proceed for the customer who is visiting the store. When the payment is completed, the information is recorded in the database 50. Specifically, a new purchase record is added to the customer's purchase history.

For the product for which the favorite setting is selected, for example, the output unit 104 outputs setting information associated with the product information acquired by the registration unit 101 and the member information of the customer to the database 50. The output product information includes, for example, a product code, a product name, a price, a selection date and time, and the like. For example, the product is set as the customer's favorite product by being added to the favorite product list in the database 50. The favorite product list recorded in the database 50 is utilized in various methods. For example, when the customer terminal 30 accesses the online store from an application or a website, the favorite product registered in the database 50 is displayed. In addition, displaying an advertisement based on data of a favorite product for a customer or reminding a store clerk or a customer of the favorite product when the customer visits the store may lead to future purchase. For example, information of favorite products accumulated in the database 50 is analyzed, and product recommendation based on customer's preference and interest is performed.

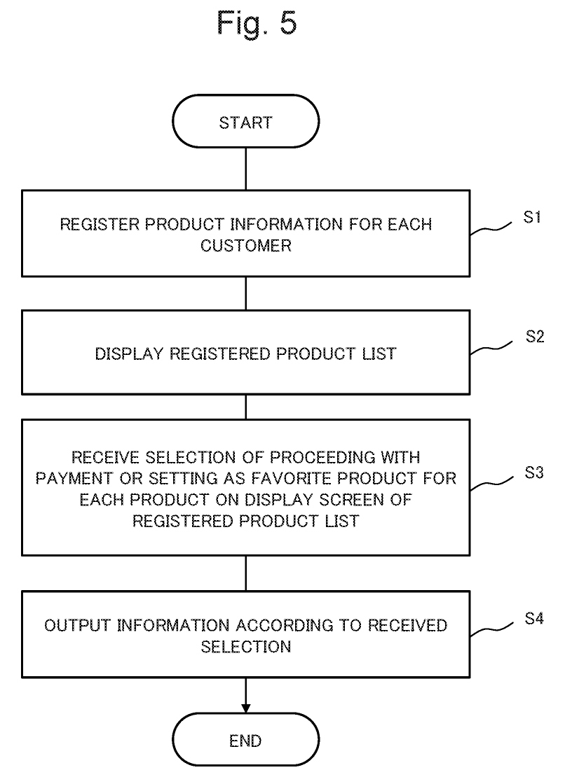

An operation example of the product management system 10 will be described with reference to FIG. 5. For example, the product management system 10 starts the processing of FIG. 5 in response to a fact that a product code is read by a store clerk for a certain customer and the product management system 10 receives product information.

In step S1, the registration unit 101 registers the product information of the product for which the operation of registering in the store has been performed for each customer. In step S2, the display control unit 102 displays a registered product list of products registered for the customer by the registration unit 101. The display screen of the registered product list allows the user to select, for each registered product, whether to proceed with the purchase in the store, or set the product as a favorite product in association with the member information of the customer.

In step S3, on the display screen of the registered product list displayed by the display control unit 102, the reception unit 103 receives, for each product, selection of whether to proceed with the purchase at the store or to set the product as a favorite product in association with the member information of the customer.

In step S4, the output unit 104 outputs information according to the selection received by the reception unit 103. That is, the output unit 104 outputs, before the customer leaves the store, payment information for proceeding with the payment of the product for which the purchase is selected to proceed. In addition, information for setting the product selected to be suspended as the customer's favorite product is output.

Thus, the product management system 10 ends the processing of FIG. 5. Note that, after step S4, the reception unit 103 may receive selection correction. In the case of performing such processing, the display control unit 102 displays the purchase product list and the favorite product list on the POS terminal 20 based on the information output in step S4, for example. On the display screen of these lists, the reception unit 103 receives an operation of changing a product for which “favorite” has been selected to “purchase” or vice versa.

According to the first example embodiment, it is possible to easily manage a product to be purchased by a customer at a store and a product to be considered for purchase later. This is because the display control unit 102 displays the registered product list of the registered products, so that the customer or the store clerk can confirm the registered products in the list. In addition, the reception unit 103 can individually select whether to proceed with the purchase at the store or set each product as a favorite product on the display screen of the registered product list. This is because the customer and the store clerk can easily and quickly classify the product. The possibility of individual selection on the display screen of the registered product list is particularly advantageous in the case of simultaneously handling a plurality of products. In particular, in a case where the store clerk makes a selection, it is possible to easily manage even in a case where it is necessary to quickly determine whether the customer likes the proposed product in the flow of customer service.

In addition, since the output unit 104 outputs appropriate information according to the received selection, it is possible to perform processing of both purchase at a store and favorite setting. As a result, the purchase behavior data of the customer in the store can be effectively collected and utilized. In particular, even in a case where the customer does not purchase the product, the data of the product is recorded as a favorite product. This makes it possible to grasp the customer's potential interest and future purchase intention.

Further, according to the first example embodiment, seamless cooperation between online and offline can be realized. A product in which a customer became interested in a store and set as a favorite product is linked with the online account of the customer. At a later date, the customer can access the online store from the home and the like and confirm the favorite product registered in the store. The online store can provide information on the stock status of the favorite product and the related product. A customer can purchase a favorite product online or visit the store again to make a purchase. As described above, the present system consistently supports a customer's purchasing process from encounter with a product in a store, consideration online, and final purchasing decision. As a result, the customer can consider purchase at his/her pace, and the store side can hold the customer's interest and obtain an opportunity to lead to future purchase. As a result, the system not only streamlines in-store product management, but also enhances the overall customer purchasing experience and enables the realization of a comprehensive sales strategy that leverages both online and offline channels.

### Modification

The first example embodiment can be modified as follows.

The registration unit 101 may associate the member information with the product information as necessary in the registration processing of the product information. In a case where the member information for uniquely identifying the customer is not acquired in the store, if the product information is registered for each customer, association with the member information is not essential. Registration data is created each time a store clerk newly handles a customer.

In the present modification, the payment information of the product to be purchased is output to the POS terminal 20 and the like as in the first example embodiment. For the setting information of the favorite product, the output unit 104 may output a code indicating the product information of the product to be set as a favorite product to the printing device. For example, a list of favorite products is held in a temporary storage area in the product management system 10 for each customer. The code indicating the product information may be a list identification number and the like that specifies the held favorite product list. In addition, the code indicating the product information may include the product information itself such as a product identifier.

The code as the setting information is output, for example, in the form of a two-dimensional code. The printing device is, for example, a receipt printer connected to the POS terminal 20. A code that is setting information is printed on the receipt of the purchased product. When the customer reads the two-dimensional code on the customer terminal 30, the favorite product is added to the customer's favorite product list. When adding the favorite product, the customer inputs the member information on the customer terminal 30. In the case of an existing member, the product information and the member information are associated with each other by logging in. In the case of a new customer, member registration can be performed.

Specifically, for example, a uniform resource locator (URL) or a two-dimensional code for accessing an application or a website is printed on the receipt of the purchased product. Then, after accessing the online store from the application or the website, the customer can add a product by further reading a code indicating product information separately. Note that a code for accessing a website and the like and a code indicating product information may be represented by a single two-dimensional code. According to this, it is possible to access a website and add a product only by reading one code.

Note that the receipt may include information for registering the history of the purchased product in association with the member information. For example, an identifier for specifying a list of purchased products, a product code of each purchased product, a purchase date and time, store information, and the like are included. These pieces of information may be included in the receipt separately from the code that is the setting information or in the same code. The customer can associate the purchase history with his/her member information by reading this information with the customer terminal 30. Examples of a method of registering a purchase history include a method of reading a two-dimensional code including a receipt number with a camera of the customer terminal 30, and a method of uploading an image of the entire receipt on an application or a website and automatically extracting receipt information using an image recognition technology.

According to the present modification, even in a case where the member information is not read in the store, the customer can set the favorite product that has not been purchased and check it later. This is a convenient function for a customer who is in a hurry or a customer who hesitates to register as a member, for example. In addition, there is an advantage that the store side can acquire the product information of interest of the non-member customer and lead to a future sales opportunity.

### Second example embodiment

A product management system 10 according to a second example embodiment will be described. In the configuration of the product management system 10 of the second example embodiment, the description of the same configuration as that of the first example embodiment will be omitted. In the second example embodiment, it is assumed that an operation of registering a product is performed in a customer terminal 30. In the store, the customer registers a product using the customer terminal 30 in order to confirm detailed information of the product of interest or purchase the product. By registering a product using the customer terminal 30, the customer does not need to line up in front of a POS terminal 20 to register a product to be purchased at the store. The payment processing for the product registered by the customer terminal 30 is performed using, for example, the customer terminal 30 or the POS terminal 20. The first and second example embodiments can be appropriately combined.

When registering the product information of the product for which the registration operation has been performed in the store for each customer, a registration unit 101 registers the product information of the product for which the registration operation has been performed on the customer terminal 30. For example, the customer downloads and uses the dedicated application on the customer terminal 30. Through this application, the customer performs an operation of registering, such as reading a product code or selecting a product on the screen.

The registration unit 101 registers the member information and the product information in association with each other. In the acquisition of the member information, information registered in advance in the customer terminal 30 can be used. For example, member registration or login is performed at the time of initial activation of the application, and the information is stored in the application. As a result, it is possible to save the trouble of inputting the member information at the time of each use.

A display control unit 102 displays information on the app screen of the customer terminal 30. Specifically, a product scan screen, a product selection screen, a display screen of a registered product list, and the like are displayed. When a customer scans a bar code or a two-dimensional code of a product on the product scan screen, product information is displayed. The displayed information includes a product name, a price, a size, a color, and the like. For example, the product selection screen displays a list of products for each category so that a customer can directly select a product on the screen. The display screen of the registered product list displays a list of scanned or selected products. Since an option such as “purchase” or “register to favorite” is displayed for each product, the display screen of the registered product list functions as a selection screen.

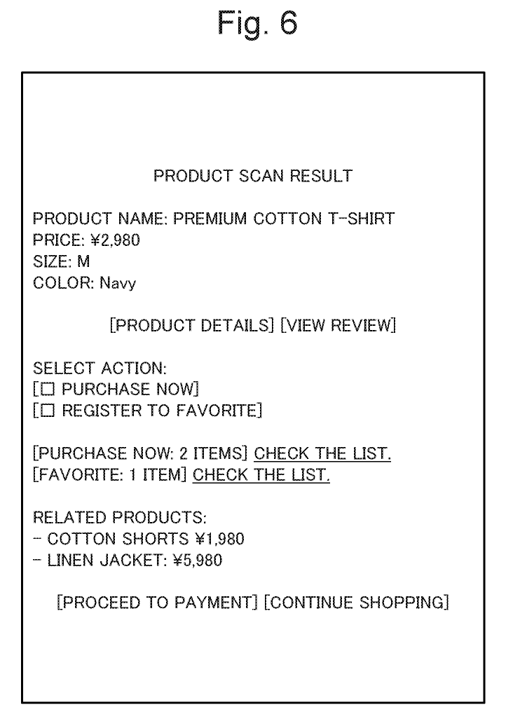

On the product scan screen, an option such as “purchase” or “register to favorite” may be displayed for the scanned product. That is, the product scan screen functions as a selection screen. An example of a product scan screen displayed on the customer terminal 30 will be described with reference to FIG. 6. On this screen, detailed information (product name, price, size, color, and the like) of the scanned product is displayed, and options such as “purchase now” and “register to favorite” are displayed below the detailed information. The customer can make this selection immediately each time the product is scanned. “Purchase now” is a button for purchasing a product at a store, and other expressions such as “put in a cart” may be used. In addition, buttons such as “product details” and “view review” are also arranged, and the customer can obtain more detailed information on the spot.

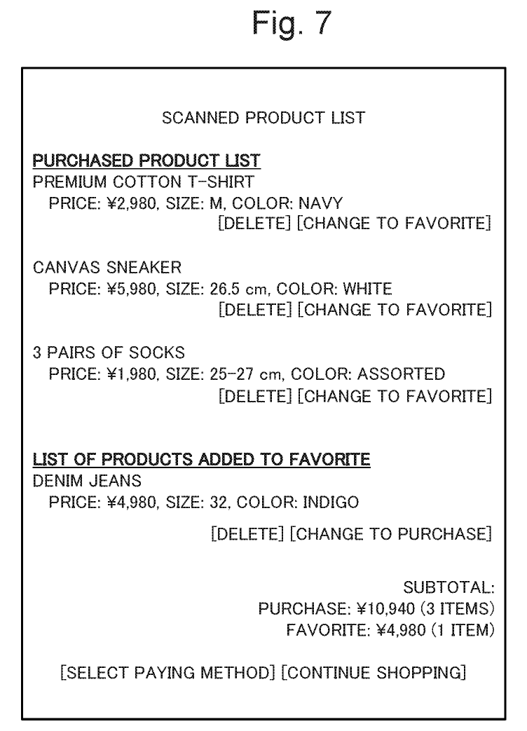

An example in which the display screen of the registered product list functions as a selection screen will be described with reference to FIG. 7. FIG. 7 illustrates an example of a confirmation screen after scanning or selecting a plurality of products. The screen of FIG. 7 is displayed, for example, in a case where the button of “proceed to payment” of the screen as illustrated in FIG. 6 is pressed. On this screen, a list of all products scanned by the customer on the day on which the customer visits the store is displayed. In addition, an operation (purchase, favorite, and the like) selected for each product is illustrated. On this screen, the customer can also change the selection content. For example, the product initially selected as the “favorite” can be changed to “purchase”, or vice versa.

A reception unit 103 accepts selection by operation on the customer terminal 30. For example, selection such as “purchase” or “register to favorite” is received for each product on the registered product list screen or the product scan screen.

An output unit 104 outputs information based on the received selection. For example, for a product for which “purchase” is selected, information for payment processing is transmitted to the server of the product management system 10 or the POS terminal 20. The product for which “register to favorite” is selected is output to the database 50 in association with the member information of the customer.

According to the second example embodiment, a customer can easily register or select a product using his/her smartphone and the like. As a result, the customer's purchase experience in the store is improved, and more efficient product management is possible. In addition, since a product that the customer is interested in can be registered as a favorite on the spot, it is easy to lead to online purchase at a later date.

The product management system 10 can have both the function described as the first example embodiment and the function described as the second example embodiment. In addition, the matters described as the screen to be displayed to the customer in the second example embodiment can be similarly applied to the screen to be displayed to the store clerk. The matters described to be displayed on the POS terminal 20 and the store clerk terminal 40 in the first example embodiment are also applicable as matters to be displayed on the customer terminal 30 in the second example embodiment.

### Modification

The first and second example embodiments can be modified as follows. These modifications improve or expand specific aspects while maintaining the basic configuration and processing flow of the first and second example embodiments. These modifications can be applied alone or in combination.

In one modification, the product management system 10 provides an option to purchase a product at an online store in addition to a purchase at a store and a favorite setting. For example, the display control unit 102 displays a button pressed in a case of purchasing a product on the online store in addition to “immediate purchase” and “favorite” on the selection screen. Such a button is, for example, a button such as “purchase later” or “add to cart”. The reception unit 103 detects that these buttons have been pressed and accepts an instruction to add the selected product to the cart of the online store. Based on this instruction, the output unit 104 outputs the information of the selected product to the database 50 and adds the product to the shopping cart associated with the customer's online store account. As a result, when the customer accesses the online store later, the product added at the store is in the cart.

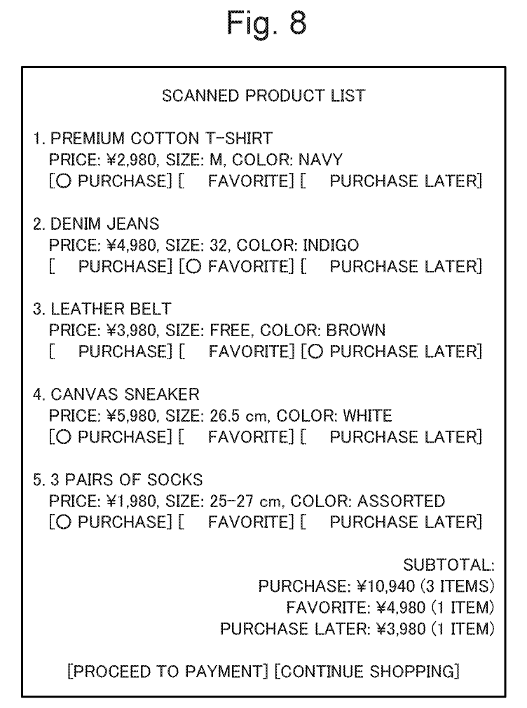

An example of a selection screen displayed by the display control unit 102 will be described with reference to FIG. 8. The screen of FIG. 8 is displayed on the customer terminal 30, for example. On this screen, detailed information such as a product name, a price, a size, and a color is displayed for each scanned product. Three options of “purchase”, “favorite”, and “purchase later” are prepared for each product, and the customer can select one of these options. A circle is displayed in the selected item. A subtotal for each category (purchase, favorite, purchase later) is displayed at the bottom of the screen so that the customer can confirm the selection content at a glance. In addition, buttons of “proceed to payment” and “continue shopping” are arranged, and the customer can easily select the next action. For example, by “proceed to payment”, the payment processing is advanced for the product to be purchased at the store. “Continue shopping” allows the customer to further scan the products in the store. Note that both the product purchased by the customer at the store and the product purchased on the online store and requested for delivery may be configured to be able to be collectively paid while the customer is at the store.

The ability to select a purchase of a product in the online store allows a customer to select an appropriate action from three options for the product, which are “purchase”, “register to favorite”, and “add to cart”. Select “purchase” to immediately purchase at the store, select “register to favorite” to add to the list for later consideration, and select “add to cart” to prepare for online purchase. As a result, the customer can flexibly respond according to his/her situation or desire. For example, it is possible to cope with various purchasing behaviors such as purchasing immediately necessary products at a store, registering a product to be thoroughly considered as a favorite, and adding a product to be delivered to a home and the like to a cart. As a result, the cooperation between the actual confirmation and the online purchase in the store is enhanced, the purchase experience of the customer is improved, and the store side can also respond to various needs of the customer.

In the present disclosure, since the favorite setting can be selected on the display screen of the registered product list in addition to the purchase in the actual store and the purchase in the online store, the customer can more flexibly make a purchasing decision. Even for a product that is not to be purchased immediately, the favorite setting is excellent in that it is possible to grasp the intention of the customer that “he/she is interested but he/she will not purchase the product immediately” that cannot be captured by addition to the cart of the online store. As a result, it contributes to building a long-term customer relationship without missing future sales opportunities. Being released from the immediate purchase pressure, the customer can enjoy shopping more comfortably. This provides a less stressful option for the customer than the alternative of addition to cart of the online store and immediate purchase.

In one modification, the product management system 10 provides a function of filling in a review or a purchase consideration memo with respect to the registered product. The display control unit 102 causes a button of “add memo” or “write review” to be displayed on the product detail screen. The reception unit 103 detects that this button has been pressed, and instructs the display control unit 102 to display a text input field. Memos and reviews input by the customer and the store clerk are received by the reception unit 103, and are output to the database 50 together with the product information by the output unit 104.

The registration unit 101 specially manages the information input by the store clerk as a service memo, and registers the service memo in association with the member information of the customer. As a result, the display control unit 102 displays the service memo at the next visit so that the store clerk can refer to the service memo. The customer can recall the features of the product, the impression of the trial fitting, and the like by checking the memo input by the customer later, and can use it as a reference when considering purchase. In addition, when comparing and considering a plurality of products, it is possible to look back on one's own memo.

In one modification, the product management system 10 provides a function of outputting sales promotion content based on a product set as a favorite to the customer terminal 30. For example, the product management system 10 provides a personalized limited offer such as a special discount coupon for a favorite product or a set sale with a related product as the sales promotion content. In addition, in a case where a favorite product becomes a target of a sale, information can be sent to the corresponding customer by e-mail or an application notification. In addition, for example, when a customer accesses an online store, the product management system 10 displays a product similar to the favorite product or a complementary product.

### Application example

The product management system of the present disclosure is applicable to various retail business modes. Specific application examples will be described below.

In the apparel store, the customer can select whether to immediately purchase the product that he/she has tried on or register the try-on product as a favorite. The product registered as a favorite can be reviewed online while the customer considers the body shape and the combination with the existing dress at home.

In a bookstore, in addition to an immediate purchase, a review or a purchase consideration memo can be written on the spot for a book to be registered as a favorite. Further, other works of authors and related books may be displayed, and an e-book purchase option may also be provided. As a result, it is possible to grasp the reading tendency of the customer and to recommend an individualized book.

In the pharmacy, it is possible to implement a function of displaying component information, a use method, and safety information on the product to be purchased on the spot. The purchase of the product registered as a favorite can be determined after the customer examines in detail at home or talks to a doctor. This is particularly effective for sales of over-the-counter medicines that do not require a prescription.

In a restaurant, a customer can select a menu for an order and sort products to order and favorite products before the order is confirmed. The menu registered as a favorite can be used as a reference for the next visit, and can also be used for future orders in take-out and delivery services.

In an electric appliance store, a customer can select whether to immediately purchase the product that he/she has viewed at the store or register the product as a favorite. The product registered as a favorite can be purchased online after the customer confirms the installation location and compatibility with existing home appliances at home.

### Hardware configuration

In the above-described example embodiments, each component of the product management system 10 represents a block of functional units. A part or all of each component of the product management system 10 may be achieved by any combination of a computer 500 and the program.

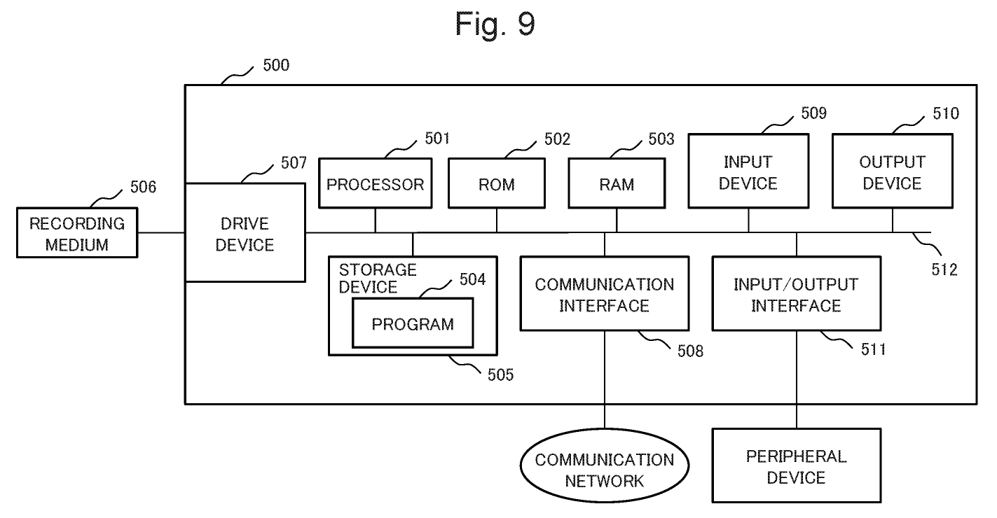

FIG. 9 is a block diagram illustrating an example of a hardware configuration of a computer 500. Referring to FIG. 9, the computer 500 includes, for example, a processor 501, a read only memory (ROM) 502, a random access memory (RAM) 503, a program 504, a storage device 505, a drive device 507, a communication interface 508, an input device 509, an output device 510, an input/output interface 511, and a bus 512.

The processor 501 controls the entire computer 500. Examples of the processor 501 include a central processing unit (CPU) and the like. The number of processors 501 is not particularly limited, and the number of processors 501 is one or more.

The program 504 includes an instruction for achieving each function of the product management system 10. The program 504 is stored in advance in the ROM 502, the RAM 503, and the storage device 505. The processor 501 achieves each function of the product management system 10 by executing instructions included in the program 504. The RAM 503 may store data to be processed in each function of the product management system 10. The communication interface 508 provides an interface with a communication network. The communication interface 508 enables communication with the POS terminal 20, the customer terminal 30, the store clerk terminal 40, and the database 50, and realizes real-time transmission and reception of the product information and the customer information.

The drive device 507 reads and writes a recording medium 506. The input device 509 is, for example, a touch panel display, a bar code reader, and the like, and receives product information and a selection input. The output device 510 is, for example, a display or a receipt printer, and outputs (displays) information to a store clerk or a customer. The input/output interface 511 provides an interface with a peripheral device. The bus 512 connects the components of the hardware. The program 504 may be supplied to the processor 501 via the communication network, or may be stored in advance in the recording medium 506, and the drive device 507 may read the program and supply the program to the processor 501.

The hardware configuration illustrated in FIG. 9 is an example, and other components may be added or some components may not be included.

There are various modifications of the implementation method of the product management system 10. For example, the product management system 10 may be achieved by any combination of a computer and a program different for each component. In addition, a plurality of components included in the product management system 10 may be achieved by any combination of one computer and a program.

At least a part of the product management system 10 may be provided in a SaaS (Software as a Service) format. That is, at least a part of the functions for achieving the product management system 10 may be executed by software executed via a network.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. The configurations in the example embodiments can be combined with each other without departing from the scope of the present disclosure.

Some or all of the above example embodiments may be described as the following Supplementary Notes, but are not limited to the following.

### Supplementary Note 1

A product management system including:

a registration means for registering product information of a product for which an operation of registering in a store has been performed for each customer;

a display control means for displaying a registered product list of the registered products;

a reception means for receiving, on a display screen of the registered product list, selection for each product as to whether to proceed with purchase at a store or to set a product as a favorite product in association with member information of a customer; and

an output means for outputting payment information for proceeding with purchase of a product or setting information for setting a product as a customer's favorite product according to the received selection.

### Supplementary Note 2

The product management system according to Supplementary Note 1, in which

the display control means causes a point of sales (POS) terminal to display a display screen of the registered product list, and

the reception means receives the selection based on an operation on the POS terminal.

### Supplementary Note 3

The product management system according to Supplementary Note 2, in which

the reception means receives the selection by a store clerk on a store clerk side display, and

the display control means further causes a customer side display to display a confirmation screen for a selection content.

### Supplementary Note 4

The product management system according to Supplementary Notes 2 or 3, in which

the reception means receives the selection by a customer on the customer side display.

### Supplementary Note 5

The product management system according to any one of Supplementary Notes 1 to 4, in which

the display control means causes a display screen of the registered product list to be displayed on a mobile terminal of a customer, and

the reception means receives the selection based on an operation on the mobile terminal.

### Supplementary Note 6

The product management system according to any one of Supplementary Notes 1 to 5, in which

the output means outputs, as the setting information, a code indicating product information of a product to be set as a favorite product to a printing device.

### Supplementary Note 7

The product management system according to any one of Supplementary Notes 1 to 6, in which

the reception means further receives selection of purchasing a product on an online store on the display screen of the registered product list, and

the output means adds information of the product to a shopping cart associated with an online store account of a customer according to the selection.

### Supplementary Note 8

The product management system according to any one of Supplementary Notes 1 to 7, in which

the registration means registers member information for identifying a customer who visits a store and the product information in association with each other.

### Supplementary Note 9

A product management method including:

registering product information of a product for which an operation of registering in a store has been performed for each customer;

displaying a registered product list of the registered products;

receiving, on a display screen of the registered product list, selection for each product as to whether to proceed with purchase at a store or to set a product as a favorite product in association with member information of a customer; and

outputting payment information for proceeding with purchase of a product or setting information for setting a product as a customer's favorite product according to the received selection.

### Supplementary Note 10

A program for causing a computer to execute processing of:

registering product information of a product for which an operation of registering in a store has been performed for each customer;

displaying a registered product list of the registered products;

receiving, on a display screen of the registered product list, selection for each product as to whether to proceed with purchase at a store or to set a product as a favorite product in association with member information of a customer; and

outputting payment information for proceeding with purchase of a product or setting information for setting a product as a customer's favorite product according to the received selection.

Some or all of the configurations described in Supplementary Notes 2 to 8 dependent on the above-described Supplementary Note 1 can also be dependent on Supplementary Notes 9 and 10 by the dependency relationship similar to that of Supplementary Notes 2 to 8. Some or all of the configurations described as the Supplementary Notes can be similarly dependent on not only the Supplementary Notes 1, and 9 and 10, but also various pieces of hardware and software, and various recording devices or systems for recording software without departing from the above-described example embodiments.

1. A product management system comprising:
at least one memory storing instructions; and
at least one processor configured to execute the instructions to:
register product information of a product for which an operation of registering in a store has been performed for each customer;
display a registered product list of the registered products;
receive, on a display screen of the registered product list, selection for each product as to whether to proceed with purchase at the store or to set the product as a favorite product in association with member information of the customer;
output, according to the received selection, payment information for proceeding with purchase of the product for a product selected to proceed with purchase at the store; and
output, according to the received selection, setting information for setting the product as a customer's favorite product for a product selected to set as the favorite product.

2. The product management system according to claim 1, wherein the at least one processor is further configured to execute the instructions to:
display the display screen of the registered product list on a point of sales (POS) terminal; and
receive the selection based on an operation on the POS terminal displaying the display screen of the registered product list.

3. The product management system according to claim 2, wherein the at least one processor is further configured to execute the instructions to:
receive the selection by a store clerk on a store clerk side display; and
display, on a customer side display, a confirmation screen for a selection content.

4. The product management system according to claim 3, wherein the at least one processor is further configured to execute the instructions to:
receive the selection by a customer on the customer side display.

5. The product management system according to claim 1, wherein the at least one processor is further configured to execute the instructions to:
display the display screen of the registered product list on a mobile terminal of a customer; and
receive the selection based on an operation on the mobile terminal.

6. The product management system according to claim 1, wherein the at least one processor is further configured to execute the instructions to:
output, to a printing device, a code as the setting information, the code indicating product information of a product to be set as a favorite product.

7. The product management system according to claim 1, wherein the at least one processor is further configured to execute the instructions to:
receive selection of purchasing a product on an online store on the display screen of the registered product list; and
add information of the product to a shopping cart associated with an online store account of a customer according to the selection.

8. The product management system according to claim 1, wherein the at least one processor is further configured to execute the instructions to:
register member information for identifying a customer who visits a store and the product information in association with each other.

9. A product management method comprising:
registering product information of a product for which an operation of registering in a store has been performed for each customer;
displaying a registered product list of the registered products;
receiving, on a display screen of the registered product list, selection for each product as to whether to proceed with purchase at a store or to set a product as a favorite product in association with member information of a customer;
outputting, according to the received selection, payment information for proceeding with purchase of a product for a product selected to proceed with purchase at the store; and
outputting, according to the received selection, setting information for setting a product as a customer's favorite product for a product selected to set as the favorite product.

10. A non-transitory computer-readable recording medium storing program for causing a computer to execute processing of:
registering product information of a product for which an operation of registering in a store has been performed for each customer;
displaying a registered product list of the registered products;
receiving, on a display screen of the registered product list, selection for each product as to whether to proceed with purchase at a store or to set a product as a favorite product in association with member information of a customer;
outputting, according to the received selection, payment information for proceeding with purchase of a product for a product selected to proceed with purchase at the store; and
outputting, according to the received selection, setting information for setting a product as a customer's favorite product for a product selected to set as the favorite product.
